(19) United States
(12) Patent Application Publication
(10) Pub. No.: US 2026/0368565 A1
(43) Pub. Date: Nov. 19, 2026

(54) OUTPUT ADMISSIBILITY CONTROL OF ARTIFICIAL INTELLIGENCE AGENT ENSEMBLES

(71) Applicant: Edwin Barton Yeary, Orinda, CA (US)

(72) Inventor: Edwin Barton Yeary, Orinda, CA (US)

(21) Appl. No.: 19/760,435

(22) Filed: Jul. 30, 2026

Related U.S. Application Data
(63) Continuation-in-part of application No. 19/294,935, filed on Aug. 8, 2025.
(60) Provisional application No. 64/058,802, filed on May 6, 2026.

(51) Int. Cl. G06N 5/043

(52) U.S. Cl. CPC G06N 5/043

(57) ABSTRACT

A method or system for managing outputs generated by a multi-agent artificial intelligence (AI) system is disclosed. A computer system processes input data with a plurality of AI agents to generate a plurality of outputs, wherein at least one of the plurality of outputs individually satisfies a respective agent-level constraint. The computer system generates a system-level output object based on the plurality of outputs. The computer system determines that the system-level output object does not satisfy one or more system-level constraints. Responsive to determining that the system-level output object does not satisfy the one or more system-level constraints, the computer system performs one or more actions comprising at least one of: blocking output of the system-level output object, or modifying the system-level output object.

### CROSS-REFERENCE TO RELATED APPLICATIONS

This application claims priority to U.S. Provisional Patent Application No. 64/058,802, filed May 6, 2026, the contents of which are incorporated by reference in its entirety. This application is a continuation in part of U.S. patent application Ser. No. 19/294,935 filed Aug. 8, 2025, the contents of which are incorporated by reference in its entirety.

### TECHNICAL FIELD

The present disclosure relates to artificial intelligence (AI) and machine learning (ML), and more specifically, to output admissibility control, constraint enforcement, and governance of autonomous agent ensembles.

### BACKGROUND

AI and ML technology typically refers to computers that have been programmed and/or taught to process data in a manner that resembles human intelligence. Generally, these computers process data, spot patterns, make predictions, and solve problems without being explicitly programmed for every possible scenario. The field continues to grow. AI systems can translate languages, diagnose medical conditions, drive cars, and create written or visual works. Autonomous agent systems may process an input with an ensemble of AI agents to produce a unified output, where each agent may have a corresponding contribution to that output.

### SUMMARY

An aspect of the present disclosure relates to a method, performed by a computer system, comprising: processing input data with a plurality of artificial intelligence (AI) agents to generate a plurality of outputs, wherein at least one of the plurality of outputs individually satisfies a respective agent-level constraint; generating a system-level output object based on the plurality of outputs; determining that the system-level output object does not satisfy one or more system-level constraints; and responsive to determining that the system-level output object does not satisfy the one or more system-level constraints, performing one or more actions comprising at least one of: blocking output of the system-level output object, or modifying the system-level output object.

In an embodiment, the determining is based on evaluating the system-level output object in view of one or more prior system-level output objects.

In an embodiment, the evaluating comprises detecting a constraint violation based on a sequence, repetition, or aggregation of the system-level output object and the one or more prior system-level output objects or based on a corresponding disposition of the one or more prior system-level output objects.

In an embodiment, the system-level output object comprises metadata associating each of the plurality of outputs with a corresponding one of the plurality of AI agents, and the determining that the system-level output object does not satisfy the one or more system-level constraints comprises determining, based on the metadata, that an action represented by the system-level output object exceeds an authority scope of one or more of the plurality of AI agents.

In an embodiment, the method further includes generating and storing a log entry comprising: an identifier of the system-level output object, an indication of the one or more system-level constraints evaluated, an indication of whether the one or more system-level constraints were satisfied, and an indication of the one or more actions performed.

In an embodiment, the determining that the system-level output object does not satisfy the one or more system-level constraints comprises determining that one or more components of the system-level output object do not satisfy the one or more system-level constraints; and the performing the one or more actions comprises modifying the one or more components that do not satisfy the one or more system-level constraints while permitting output of remaining components.

In an embodiment, the one or more system-level constraints are dependent on a time associated with processing the input data, such that the system-level output object satisfies the one or more system-level constraints at a first time and does not satisfy the one or more system-level constraints at a second time.

In an embodiment, the one or more system-level constraints are retrieved from a constraint registry that is external to and not modifiable by the plurality of AI agents.

Aspects of the present disclosure relate to a system comprising one or more processors and a memory storing instructions that, when executed by the one or more processors, configure the system to perform any of the described operations. Such a system may reside on one or more servers, for example, in a distributed compute environment. Aspects of the present disclosure relate to a non-transitory computer-readable medium storing instructions that, when executed by one or more processors, cause the one or more processors to perform any of the described operations.

In some aspects and embodiments, the system comprises a separate admissibility layer that receives outputs from a plurality of AI agents and performs the described operations, including generating a system-level output object, determining whether the system-level output object satisfies one or more system-level constraints, and performing one or more actions responsive to the determination. The admissibility layer may operate independently of the AI agents that generated the outputs, such that the admissibility layer receives the outputs without itself processing the input data with the plurality of AI agents.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 shows a computer system that controls the behavior of one or more autonomous agents through a control layer, in accordance with some embodiments.

FIG. 2 shows a system workflow for evaluating and controlling outputs generated by a plurality of AI agents, in accordance with some embodiments.

FIG. 3 shows an example data structure of a system-level output object, in accordance with some embodiments.

FIG. 4 shows the structure of a log entry for recording admissibility determinations, in accordance with some embodiments.

FIG. 5 shows a constraint set and a constraint registry for storing and organizing constraints in a hierarchical structure, in accordance with some embodiments.

FIG. 6 illustrates an example method for system-level output admissibility control, in accordance with some embodiments.

FIG. 7 shows a computer system that may be used to support the systems and operations described, in accordance with some embodiments.

### DETAILED DESCRIPTION

Aspects of the present disclosure relate to artificial intelligence (AI), and agentic AI. Agentic AI refers to artificial intelligence that is configured to operate with a degree of autonomy to achieve goals through decision-making and action-taking, as opposed to simply responding to prompts or performing a strict input/output operation. Agentic AI can make decisions and take actions without constant human direction, operating based on their programming and learned behaviors. Agents work toward specific objectives, whether explicitly programmed or learned through training. They can perceive their environment (digital or physical) and act within it. Actions may include accessing databases, calling APIs to interact with websites or other applications, generating control commands to operate and control machinery or robots, interacting with humans, displaying or processing data, or organizing memory, to name a few. Agents are configured to evaluate situations and choose from multiple possible actions based on their understanding of the current state and desired outcomes. Unlike single-interaction AI systems, agents can be configured to operate continuously over time, maintaining state and context over time and/or over multiple actions. Modern artificial neural networks (ANNs) may serve as the core machine learning model of many AI agents. An ANN may produce outputs by propagating input data through multiple internal layers, generating intermediate numerical representations (activation data) at each stage of inference.

Autonomous artificial intelligence (AI) systems are evolving from single-agent assistants into multi-agent ensembles capable of generating, evaluating, refining, delegating, and executing actions across tools, applications, networks, physical systems, and external services. Existing approaches commonly rely on internal evaluation mechanisms, including reward models, critic agents, recursive optimization loops, tool-specific workflow constraints, prompt-based safety policies, content filters, identity systems, or post-hoc monitoring. These mechanisms may evaluate quality or correctness, but they remain inside or adjacent to the agent generation process and may share the same optimization pressures as the agents being evaluated. Additionally, existing approaches may fail to detect when multiple agents produce individually valid outputs that become collectively inadmissible, when agents operating under different roles or trust domains generate incompatible actions, when internal agreement among agents produces synthetic consensus, when an output is correct but unauthorized, when an output is safe in isolation but unsafe in sequence, or when agent-to-agent interactions create emergent system behavior that violates authority, domain, temporal, regulatory, or interaction constraints. As a result, existing approaches may not adequately provide an enforceable external admissibility boundary for dynamic, composite, system-level outputs produced by interacting autonomous agents.

Aspects of the present disclosure address deficiencies of existing systems such as those noted above by introducing an admissibility control layer that operates outside the internal reasoning and optimization mechanisms of participating agents. The system receives one or more outputs from one or more autonomous agents, normalizes the outputs into a system-level output object representing the proposed content, action, target, context, provenance, authority basis, dependencies, and/or intended external effect, and evaluates the system-level output object against applicable constraints retrieved from a constraint registry. The constraint registry may include authority constraints, domain constraints, interaction constraints, temporal constraints, system-state constraints, stateful-sequence constraints, risk constraints, regulatory constraints, safety constraints, and organizational constraints, including constraints that are not modifiable, overridable, optimized, learned away, subordinated, or adapted by the autonomous agent ensemble. The system determines whether the system-level output object is admissible before execution, transmission, publication, tool invocation, storage, actuation, memory modification, transaction commitment, workflow transition, or other externalization, and an execution control gate permits, blocks, modifies, delays, degrades, partially executes, sandboxes, routes, or escalates the system-level output object based on the admissibility determination. The admissibility determination may be performed independently of the internal reasoning, reward functions, optimization objectives, self-evaluation mechanisms, planning loops, critic-agent approvals, or consensus signals of the participating agents, and the system may determine that a composite system-level output is inadmissible even when one or more contributing agent outputs are individually admissible, factually correct, high-confidence, or internally approved.

In an aspect of the present disclosure, a computer system is configured to process input data with a plurality of AI agents to generate a plurality of outputs. At least one of the plurality of outputs individually satisfies a respective agent-level constraint. The system generates a system-level output object based on the plurality of outputs. The system determines that the system-level output object does not satisfy one or more system-level constraints. Responsive to determining that the system-level output object does not satisfy the one or more system-level constraints, the system performs one or more actions. The one or more actions may comprise blocking output of the system-level output object or modifying the system-level output object. The system-level output object may comprise metadata associating each of the plurality of outputs with a corresponding one of the plurality of AI agents, and the system may generate and store a log entry comprising an identifier of the system-level output object, an indication of the one or more system-level constraints evaluated, an indication of whether the one or more system-level constraints were satisfied, and an indication of the one or more actions performed.

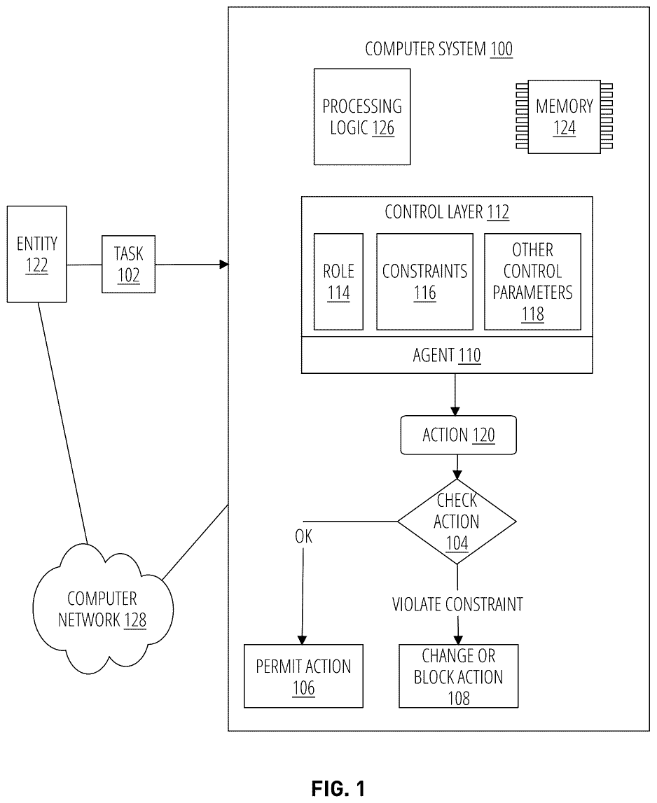

FIG. 1 shows a computer system that controls the behavior of one or more autonomous agents through a control layer, in accordance with some embodiments.

The computer system 100 includes memory 124, and processing logic 126. Processing logic 126 may comprise one or more processors such as, for example, one or more central processing units (CPUs), and/or one or more graphics processing units (GPUs), and/or other processing devices. Processing logic may include an application, an operating system, a service, a subroutine, embedded instructions or a script, an agent that is governed by a control layer, or a combination thereof. It should be understood that actions described as being performed by processing logic or a computer system throughout the present disclosure, may be interpreted as being performed by the agent, or a service or routine executing separate from the agent, or a combination thereof. Computer system 100 comprises memory 124, which may comprise random access memory (RAM), video RAM (VRAM), cache, disk, solid state drives (SSD), hard disk drives (HHD), or other computer-readable memory. The computer system 100 may be connected to a computer network 128. Computer network 128 may include a collection of interconnected computing devices that can communicate and share resources, such as files, applications, printers, and internet access. Network devices such as routers and switches direct network traffic between different networks, or manage traffic within a single network. Network nodes such as computers, servers, smartphones, and other hardware, are connected via communication links like cables, Wi-Fi, or satellite connections. Computer system 100 may represent a plurality of computer nodes and/or services (e.g., in a microservices application) which may be distributed over the computer network 128 on separate devices, configured to work together to perform the described operations.

Computer system 100 is configured to instantiate a control layer 112 in memory 124, and attach the control layer 112 to an agent 110. In some embodiments, computer system 100 may load agent 110 to memory 124, where the agent 110 is ready for handling tasks. Prior to instantiation, a control layer may comprise a class (e.g., a plain old java object (POJO)), or other machine instantiable data structure, which may include placeholders for control layer parameters which are initiated upon instantiation. The control layer may comprise an application programming interface (API) or other interface that allows the computer system 100, an agent, and/or other services operating in the computer system 100 to communicate with and/or extract parameters from (e.g., role, constraints, etc.).

The control layer 112 may comprise at least a role 114, and constraints 116. The role 114 defines the role of agent 110, such as its functional identity and/or domain of operation. The constraints 116 may comprise one or more constraints, or a plurality of constraints 116.

In some embodiments, computer system 100 forms the constraints 116 as a constraint stack or a hierarchical constraint stack. A hierarchical constraint stack may be constructed as a data structure with elements (e.g., constraints) stored in a tree data structure with parent-child relationships. This means that some constraints serve as parents to others, and this pattern is repeated throughout the structure. By constructing the constraints as a hierarchical stack, processing logic allows for efficient storage, retrieval, and implementation of constraints, while using a natural hierarchical or nested structure that is complementary in defining roles for agents.

The constraints 116 define the permissible actions of the agent 110 to which the control layer 112 is attached. Additional control parameters 118 may be included in the control layer 112 to further modulate agent behavior, such as tone, privilege levels, or escalation logic, as described in other sections.

The computer system 100 may receive a task 102 from an entity 122. The entity 122 may represent an external or internal actor (such as a user, administrator, or another system component) that may interact with the computer system 100 and initiate tasks. In some examples, the computer system 100 and the entity 122 may be one and the same, for example, the computer system 100 may generate one or more tasks to simulate operation of the agent 110 and other system components, as described in other sections. In other examples, the entity 122 may comprise a service, a subroutine, an application, a network node, or other entity that is separate from the computer system 100.

A task 102 is an assignment or objective received by the computer system 100 that requires execution by an agent 110. Tasks 102 can vary widely depending on the domain and the agent's role 114. For example, a task 102 may include generating a summary of data for a client, drafting an email update for a team, generating a control command for operational technology (OT), arranging travel accommodations, processing physical sensor data, determining a vehicle driving route or vehicle actuator commands, or reviewing a document for compliance. Each task may represent a distinct operation or set of operations, with a target outcome, that the system may assign to one or more agents to perform.

The computer system 100 may select agent 110 based on role alignment with task 102. For example, upon receiving a task 102, the computer system 100 evaluates the available agents, which may include those that are already loaded in memory 124, and selects agent 110 for task execution based on the agent's role 114 and its alignment with one or more characteristics of the task 102. For example, if the task 102 is to generate vehicle control commands, and role 114 indicates a corresponding role intended to generate vehicle control commands, computer system 100 selects the agent 110 with attached control layer 112 for the task 102.

The computer system 100 may direct the agent 110 (e.g., through signaling, an application programming interface (API), or other communication means) to process and perform the task 102.

As the agent 110 proceeds to process the task 102 (e.g., as input to the agent's underlying ML model) each proposed action 120 generated by the agent 110 is evaluated by the computer system 100 against the control layer 112 at block 104. It should be understood that the agent itself can be configured to perform the evaluation of its action against the control layer 112, or this functionality may be performed by the larger computer system 100 and one or more services thereof, or a combination thereof.

At block 104, the computer system 100 determines whether the action 120 satisfies all applicable constraints 116 in the constraint stack. If the action 120 is found to violate one or more of the constraints 116, the computer system 100 may block the action 120 or modify the action 120 to ensure compliance before execution. For example, action 120 may include an attempt to execute a structured query to retrieve data from a database as part of a data mining operation. Other examples of action 120 might include sending a network request to a remote system to claim an object or resource, annotate a digital document, generate an audio signal, or determine a network resource to use in a telecommunication operation.

Each action 120 is evaluated against the control layer 112 (e.g., against the constraints 116, role 114, and/or other control parameters 118) to check that the action 120 satisfies the relevant constraints 116. If the action 120 satisfies the constraints 116 and/or other parameters of the control layer 112, then computer system 100 proceeds to block 106 and permits the agent 110 to perform the action 120.

In response to determining that the action 120 does not satisfy the constraints 116 and/or the other control parameters 118, computer system 100 proceeds to block 108 to change or block the action 120. For example, computer system 100 may change the action 120 to refer to a different database or memory location that is permitted by constraints 116, or completely block the agent 110 from performing the action 120.

In some embodiments, computer system 100 may signal to the agent 110 to discontinue the action 120, or prevent an outbound signal from agent 110 from reaching its intended destination. The mechanism for blocking or changing action 120 may vary, depending on the task 102, the agent 110, and/or the action 120.

The computer system 100 works to ensure that every agent operates within a clearly defined role and set of constraints. This supports dynamic, context-aware task assignment and execution that aligns with efficient memory management and access, cybersecurity concerns, and other data policies. By evaluating and enforcing constraints in real time, blocking or modifying actions that do not comply, the system restricts the agent's actions in a controlled manner.

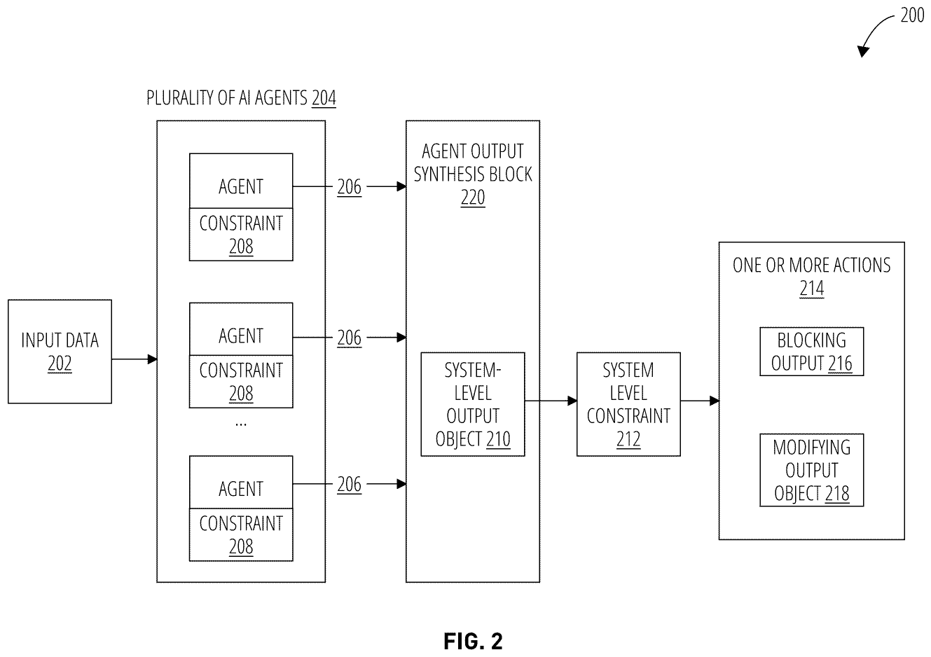

FIG. 2 shows a system workflow 200 for evaluating and controlling outputs generated by a plurality of AI agents, in accordance with some embodiments. The system workflow 200 may be performed by a computer system or processing logic thereof, as described in other sections such as with respect to FIG. 1. The system workflow 200 may be performed by a computing device that is configured to process input data with one or more AI agents, evaluate system-level outputs against applicable constraints, and control whether and how an output may be executed, externalized, modified, escalated, delayed, partially executed, degraded, sandboxed, routed, or blocked.

The system receives input data 202 to be processed by a plurality of AI agents 204. The input data 202 may comprise any data requiring processing by an autonomous agent ensemble, including natural language prompts, structured action requests, tool invocation requests, workflow transition requests, transaction proposals, control commands, or combinations thereof.

Processing logic applies the plurality of AI agents 204 to the input data 202 to generate a plurality of outputs 206. The plurality of AI agents 204 may correspond to AI agents with control layers as described in other sections, such as with respect to FIG. 1. The plurality of AI agents 204 may include generators, evaluators, planners, critics, tool-using agents, retrieval agents, compliance agents, domain-specific agents, supervisor agents, external third-party agents, human-proxy agents, or combinations thereof. In some embodiments, the plurality of AI agents 204 may include agents operating under different trust domains, ownership structures, administrative domains, authority models, or technical architectures. The system may operate across heterogeneous agents, models, tools, orchestration systems, APIs, messaging systems, workflow engines, or external agent frameworks without requiring modification of the internal architecture of participating agents. In some embodiments, processing logic may operate as an admissibility system that is independent of the plurality of AI agents that generated the outputs. The admissibility system may receive the plurality of outputs from the AI agents without itself processing the input data with the AI agents, and may perform the described operations including generating the system-level output object, evaluating the system-level output object against one or more system-level constraints, and performing one or more actions responsive to the evaluation.

Each AI agent in the plurality of AI agents 204 may operate under a respective agent-level constraint 208 that governs permissible actions, available memory, domain, output characteristics, or other constraints for that individual agent. The agent-level constraint 208 may correspond to a control layer as described in other sections, such as, for example, control layer 112 and constraints 116 as described with respect to FIG. 1. Constraints 208 may include role definitions, constraint stacks, tone vectors, privilege levels, escalation logic, or other behavioral governance parameters. Each AI agent in the plurality of AI agents 204 generates a corresponding output 206. The plurality of outputs 206 may individually satisfy the respective agent-level constraint 208 associated with the generating AI agent. However, individual agent-level admissibility may not ensure system-level admissibility; outputs that are individually compliant may produce undesirable, unauthorized, or inadmissible outcomes when combined, sequenced, or externalized together.

The plurality of outputs 206 may include natural language responses, structured action proposals, API calls, tool invocations, database writes, memory writes, document edits, messages or notifications, financial transactions, procurement actions, control commands, workflow transitions, execution plans, actuator instructions, publication events, routing decisions, delegated tasks, composite decision artifacts, sequences or combinations of the foregoing.

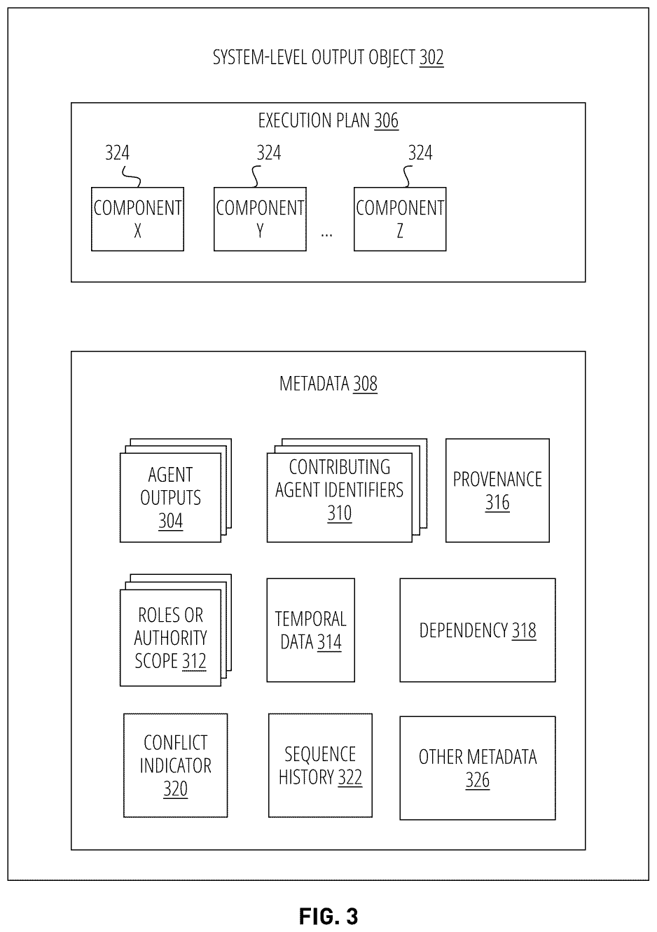

At agent output synthesis block 220, processing logic collects, merges, selects, synthesizes, or otherwise aggregates the plurality of outputs 206 into a system-level output object 210. The system-level output object 210 may represent a sum, concatenation, combination, or subset of the individual agent outputs, or may represent a synthesized action that is distinct from any individual agent output. The system-level output object 210 may include an execution plan that represents an action or series of actions that are to be externalized as a result of synthesizing or combining the plurality of outputs 206. For example, if a first agent output proposes a data retrieval action and a second agent output proposes a formatting transformation, the synthesized system-level output object 210 and execution plan therein may represent a combined action that retrieves data and applies the transformation, or may represent a different action generated based on the synthesis of both outputs. The system-level output object 210 may, in some embodiments, include an invocation to an API, tool, or library; an instruction to access or modify data; a transmission of a signal or message; an actuation command; a workflow transition; or other proposed external effect. Processing logic may preserve conflicting elements, identify output components, attach provenance metadata, tag contributing agents, identify intended external effects, preserve execution dependencies, and generate conflict indicators. The system-level output object 210 represents the proposed output to be evaluated at the externalization boundary and may represent not only the content or command produced by agents, but also the intended target, authority basis, execution context, dependencies, provenance, and expected external effect of the proposed output. The system-level output object 210 is described in further detail with respect to FIG. 3.

The externalization boundary is the control point at which a proposed output transitions from internal computation to external effect. An external effect includes any action, state change, communication, commitment, or operation that extends beyond the internal computation of the autonomous agent system. External effects may include transmitting a signal and/or a message over a computer network, invoking an API, calling a tool, publishing content, modifying a document, writing to a database, writing to agent memory, creating or modifying a calendar event, approving a purchase, initiating a transaction, placing a trade, executing a contract workflow, changing access rights, triggering a downstream system, controlling a robot, vehicle, device, or actuator, committing a workflow transition, notifying a user or third party, or storing an output in a persistent record. The system evaluates the system-level output object 210 at the externalization boundary before permitting any external effect to occur.

Processing logic evaluates the system-level output object 210 against a system-level constraint 212. The system-level constraint 212 is distinct from the agent-level constraints 208; while agent-level constraints govern individual agent behavior, system-level constraints govern the admissibility of composite outputs at the externalization boundary. The system-level constraint 212 may be retrieved from a constraint registry. Generally, the constraint registry may store machine-readable constraints and associated metadata used by processing logic to evaluate, modify, filter, and/or block the system-level output object 210. The one or more system-level constraints 212 can include one or more of: role definitions, authority levels, permissions, domain boundaries, interaction boundaries, trust-domain boundaries, risk thresholds, escalation rules, temporal constraints, approval requirements, external validation requirements, non-optimizable constraints, constraint precedence rules, constraint inheritance relationships, cross-system governance rules, jurisdiction-specific requirements, organization-specific policies, user-consent rules, or execution target rules. The constraint registry may be local, distributed, hierarchical, cryptographically verifiable, administratively configured, dynamically updated, or synchronized with external policy, identity, compliance, legal, regulatory, or authorization systems.

In some embodiments, the system-level constraint 212 includes constraints that are not modifiable, overridable, optimized, learned away, subordinated, or adapted by the plurality of AI agents 204. The constraint registry may include data protections that block modification by AI agents, and processing logic may override the system-level constraints if attempted by an AI agent. Such constraints may include authority limits, regulatory requirements, safety thresholds, domain boundaries, organizational policies, legal restrictions, user-consent requirements, privacy requirements, external system permissions, human approval requirements, fiduciary limits, and clinical scope-of-practice limits. These constraints may be enforced by the system regardless of agent-generated confidence signals, internal agreement, reward scores, self-evaluation, critic-agent approval, or consensus among agents. Non-optimizable constraints may be enforced authoritatively, deterministically, or fail-closed by the system and may take precedence over adaptive, local, workflow-level, agent-generated, or preference-based constraints.

Processing logic evaluates the system-level output object 210 against the system-level constraint 212 and may determine admissibility using one or more admissibility algorithms. For example, the admissibility algorithms may include rule-based constraint matching, hierarchical constraint stack evaluation, policy graph evaluation, authority verification, permission checking, domain boundary evaluation, interaction boundary evaluation, risk scoring, conflict detection, composite output analysis, threshold-based gating, multi-stage admissibility evaluation, sequential output transition evaluation, stateful context evaluation, temporal context evaluation, constraint conflict resolution, escalation policy application, external validation routing, simulation or dry-run execution, dependency analysis, or provenance analysis. The evaluation may produce binary admissibility, graded admissibility, conditional admissibility, partial admissibility, degraded admissibility, component-level admissibility, sequence-level admissibility, an escalation requirement, a modification requirement, a delay requirement, or rejection.

In some embodiments, the system may determine that a system-level output is inadmissible even when each contributing agent output is independently admissible. Composite inadmissibility refers to a condition in which two or more outputs, actions, or output components are individually admissible but become inadmissible when combined, sequenced, delegated, merged, selected, synthesized, or externalized together. For example, a first agent may detect network traffic anomalies and propose a firewall rule adjustment that is individually admissible under a threat-response constraint, and a second agent may detect unusual user behavior and propose an access restriction that is individually admissible under an account-security constraint, but the combined output may be inadmissible because it creates a system lockdown that exceeds the authority scope of either agent, disrupts critical services without proper escalation, or triggers automated responses that conflict with an active incident-response protocol. Processing logic may detect composite inadmissibility by evaluating interactions among output components, cumulative risk, cross-agent conflicts, authority overlap, incompatible domain assumptions, sequencing effects, hidden dependencies, prior approved or rejected outputs, downstream execution consequences, and systemic risk introduced by the combined output.

In some embodiments, processing logic evaluates admissibility across a sequence of proposed outputs or external effects. A proposed output may be admissible when evaluated in isolation but inadmissible when evaluated in view of prior outputs, pending outputs, cumulative effects, repeated actions, dependency chains, or downstream workflow transitions. Processing logic may maintain or access an admissibility state history comprising prior permitted outputs, blocked outputs, degraded outputs, escalations, authority changes, risk accumulation, temporal events, and dependency relationships. Processing logic may compare a proposed system-level output object against this state history to determine whether the proposed output creates an inadmissible transition, exceeds cumulative thresholds, repeats a previously rejected action, bypasses an approval sequence, or produces an unauthorized aggregate effect.

In some embodiments, admissibility is time-dependent. An output may be admissible at a first time and inadmissible at a second time based on changes in authority scope, domain constraints, system state, environmental context, risk thresholds, regulatory requirements, prior outputs, user permissions, market conditions, clinical state, emergency conditions, or other external events. Processing logic evaluates admissibility dynamically at or near the time of execution or externalization.

In some embodiments, processing logic evaluates action admissibility independently from identity validity. An agent, user, service, or system may have valid identity credentials and may be authenticated to access a system, while still lacking authority to externalize a particular output or perform a particular action. Processing logic may block, modify, delay, degrade, or escalate a proposed output even when the actor identity is valid, if the proposed output exceeds authority, violates domain boundaries, conflicts with applicable constraints, or creates an inadmissible external effect.

Responsive to determining that the system-level output object 210 does not satisfy the system-level constraint 212, processing logic performs one or more actions 214. The one or more actions 214 may comprise at least one of blocking output 216 of the system-level output object 210, or modifying system-level output object 218. Processing logic may block an execution plan of the system-level output object, modify the execution plan, partially execute the execution plan by permitting admissible components while blocking inadmissible components, delay execution of the execution plan, sandbox the execution plan, or convert the execution plan into a degraded admissible form. Processing logic serves as an execution control gate that applies the admissibility determination to the system-level output object 210 before the proposed external effect occurs. The execution control gate may allow the output, block the output, modify or transform the output, redact part of the output, insert a constraint-compliant alternative, delay execution, require higher-level approval, escalate to another authority level, route the output to an external validation system, execute admissible subcomponents while blocking inadmissible subcomponents, split the output into component-level admissibility paths, prevent externalization while preserving internal state, sandbox the output, rate-limit execution, require user confirmation, require human-in-the-loop review, mark the output for audit or review, or convert the output into a degraded admissible form. The execution control gate enforces the admissibility determination independently of probabilistic outputs, confidence scores, reward signals, or internal evaluation signals produced by the agent ensemble.

In some embodiments, processing logic may assign a degraded admissibility state in which an output is not fully admissible as proposed but may be executed in a reduced, constrained, redacted, rate-limited, sandboxed, reversible, or lower-authority form. The execution control gate may convert an inadmissible or conditionally admissible output into a degraded admissible output by reducing scope, limiting authority, redacting content, requiring confirmation, sandboxing execution, selecting a safer fallback, applying a lower-risk version of the action, executing only reversible subcomponents, requiring additional approval, limiting downstream propagation, converting an action into a recommendation, or converting an external action into an internal action for self-inspection.

In some embodiments, processing logic determines that one or more components of the system-level output object 210 do not satisfy the one or more system-level constraints 212. Responsive to this determination, processing logic may perform the one or more actions 214 by modifying the one or more components that do not satisfy the one or more system-level constraints while permitting output of remaining components. Processing logic may evaluate a system-level output object comprising multiple output components, determine a component-level admissibility state for each output component, permit execution or externalization of one or more admissible components, and block, modify, delay, degrade, sandbox, or escalate one or more inadmissible or conditionally admissible components.

In some embodiments, the admissibility evaluation engine may select an evaluation mode based on latency, risk, domain, or execution criticality. Low-risk outputs may be evaluated using cached, precompiled, or simplified constraint checks. Higher-risk outputs may trigger multi-stage evaluation, escalation, external validation, simulation, or human approval. In real-time systems, the execution gate may apply a fail-safe default, degraded admissibility state, pre-authorized fallback action, or local emergency constraint when evaluation cannot complete within a defined latency window. Evaluation modes may include synchronous blocking evaluation, asynchronous evaluation, streaming evaluation, incremental evaluation, fast-path approval, slow-path escalation, cached admissibility determination, precompiled constraint graph evaluation, fail-closed blocking, or fail-safe fallback execution.

When constraints conflict, processing logic may resolve the conflict using one or more of predefined priority ordering, regulatory supremacy rules, safety precedence rules, domain precedence, authority hierarchy, risk-weighted scoring, least-privilege selection, human escalation, external validation, fail-closed blocking, conditional execution, partial admissibility, degraded admissibility, or deterministic constraint resolution policies. In some embodiments, higher-level constraints override lower-level constraints. In some embodiments, non-optimizable constraints, regulatory constraints, safety constraints, and authority constraints override local task constraints, workflow constraints, agent preferences, internal agent evaluations, or user convenience preferences.

In some embodiments, processing logic receives governance metadata from one or more upstream governance layers. Such metadata may include role identifiers, active constraint stacks, authority scopes, memory-scope indicators, tool-use permissions, agent confidence signals, ensemble conflict indicators, deadlock or convergence indicators, provenance graphs, latent-pathway governance indicators, prior admissibility states, or prior externalization decisions. Processing logic may use such metadata as inputs to the admissibility evaluation without requiring modification of the participating agents or underlying models. For example, an output generated by an agent operating under a restricted role may be evaluated under a different authority constraint than an output generated by an agent operating under a supervisory role. Similarly, an ensemble output associated with convergence, synthetic consensus, unresolved conflict, or latent-pathway suppression may trigger a higher-risk admissibility mode, external validation, human approval, sandboxing, or degraded admissibility.

FIG. 3 shows an example data structure of a system-level output object 302, in accordance with some embodiments. The system-level output object 302 may correspond to the system-level output object 210 described with respect to FIG. 2, or more generally to any system-level output object described throughout the present disclosure. As described in other sections, system-level output object 302 may be generated by processing logic as a composite or synthesis of a plurality of outputs of AI agents.

The system-level output object 302 may include an execution plan 306. The execution plan 306 may comprise one or more components 324 representing the proposed actions, steps, or sub-tasks to be performed. The one or more components 324 may represent individual elements of a multi-step execution plan, structured action proposals, workflow transition requests, tool invocations, API calls, database operations, memory writes, external communications, actuator commands, or sequences of operations. For example, an execution plan 306 may include a first component X representing a data retrieval operation, a second component Y representing a transformation or analysis step, and a third component Z representing a transmission or storage action. Each component in the one or more components 324 may be individually and/or in combination, evaluated for admissibility, such that processing logic may permit execution or externalization of one or more admissible components while blocking, modifying, delaying, degrading, sandboxing, or escalating one or more inadmissible or conditionally admissible components.

The system-level output object 302 may include metadata 308. The metadata 308 may include information associated with the system-level output object 302 that supports admissibility evaluation, provenance tracking, authority verification, conflict detection, temporal analysis, dependency analysis, and audit capabilities. The metadata 308 may include agent outputs 304. The agent outputs 304 may comprise one or more outputs generated by the plurality of AI agents that were aggregated, synthesized, or selected to form the execution plan 306. The agent outputs 304 may include selected outputs, merged outputs, synthesized outputs, structured action proposals, execution instructions, tool invocation requests, external communication payloads, memory write operations, workflow transition requests, transaction proposals, control signals, decision artifacts, composite outputs containing conflicting or partially incompatible elements, or output sequences.

The metadata 308 may include contributing agent identifiers 310, which associate each of the agent outputs 304 with a corresponding one of the plurality of AI agents. The contributing agent identifiers 310 enable the system to track which agent generated which output, supporting provenance tracking, authority verification, and audit capabilities.

The metadata 308 may include roles or authority scope 312 of the contributing agents. The roles or authority scope 312 may define the functional identity, domain of operation, trust domain, ownership structure, administrative domain, or authority level of each contributing agent. Processing logic may evaluate an output generated by an agent operating under a restricted role under a different authority constraint than an output generated by an agent operating under a supervisory role.

The metadata 308 may include temporal data 314. The temporal data 314 may include timestamps, temporal context, time-dependent constraint indicators, or other time-related information associated with the system-level output object 302. Processing logic may use the temporal data 314 to evaluate whether an output is admissible at or near the time of execution or externalization, as admissibility may be time-dependent based on changes in authority scope, domain constraints, system state, environmental context, risk thresholds, regulatory requirements, prior outputs, user permissions, market conditions, or other external events.

The metadata 308 may include provenance 316. The provenance 316 may include provenance metadata, source references, constraint tags, or other information indicating the origin, source, and chain of custody of the agent outputs 304 and the system-level output object 302. Processing logic may use the provenance 316 to perform provenance analysis as part of admissibility evaluation, to verify authority basis, to support audit capabilities, and to enable traceability of outputs to their generating agents and source data.

The metadata 308 may include one or more dependencies 318. The one or more dependencies 318 may define dependency relationships indicating which elements depend on other elements for execution or validity. The one or more dependencies 318 may include one or more of: dependencies among components 324 of the execution plan 306, dependencies among agent outputs 304, dependencies on prior outputs in the sequence history 322, execution dependencies, or dependency chains. Processing logic may use the one or more dependencies 318 to perform dependency analysis as part of admissibility evaluation, to detect hidden dependencies, to evaluate whether a sequence of outputs creates an inadmissible transition, and to determine the impact of blocking or modifying one element on other dependent elements.

The metadata 308 may include conflict indicator 320. The conflict indicator 320 may indicate the presence of conflicting or partially incompatible elements among the agent outputs 304, cross-agent conflicts, authority overlap, incompatible domain assumptions, or other conflicts detected during aggregation or evaluation. Processing logic may use the conflict indicator 320 to detect composite inadmissibility, to trigger escalation or human approval, or to apply conflict resolution mechanisms such as predefined priority ordering (applying a fixed ranking among constraint types), regulatory supremacy rules (giving precedence to regulatory constraints over other constraints), safety precedence rules (prioritizing safety constraints over non-safety constraints), domain precedence (resolving conflicts based on domain hierarchy), authority hierarchy (deferring to higher-authority constraints), risk-weighted scoring (selecting the lower-risk option), least-privilege selection (choosing the more restrictive option), or fail-closed blocking (blocking the output when conflict cannot be resolved).

The metadata 308 may include sequence history 322. The sequence history 322 may include prior admissibility states, prior permitted outputs, blocked outputs, degraded outputs, escalations, authority changes, risk accumulation, temporal events, dependency relationships, or other historical information regarding prior system-level outputs. Processing logic may use the sequence history 322 to evaluate whether a proposed output is admissible in view of prior outputs, cumulative effects, dependency chains, repeated actions, and historical admissibility states. Processing logic may compare a proposed system-level output object against this state history to determine whether the proposed output creates an inadmissible transition, exceeds cumulative thresholds, repeats a previously rejected action, bypasses an approval sequence, or produces an unauthorized aggregate effect.

The metadata 308 may include other metadata 326. The other metadata 326 may include confidence signals, risk scores, domain classifications, escalation history, intended external effect, execution target, constraint tags, interaction boundary indicators, trust-domain boundary indicators, agent consensus indicators, critic-agent approval signals, reward scores, self-evaluation results, or any other metadata useful for admissibility evaluation, audit, compliance, or governance purposes. The other metadata 326 may be used by processing logic to evaluate admissibility, to support traceability, replay, compliance review, debugging, incident investigation, liability analysis, regulatory reporting, future admissibility determinations, training and evaluation of autonomous agent systems, or enterprise oversight.

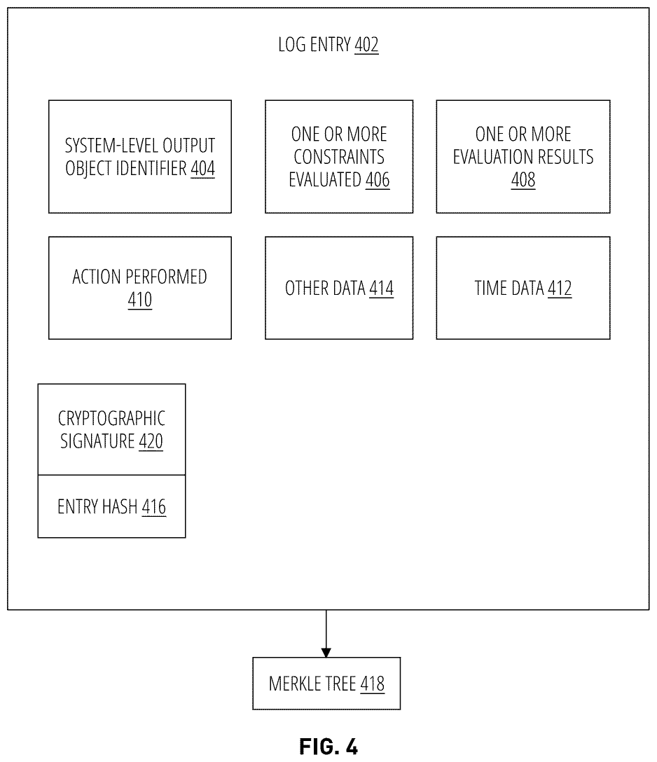

FIG. 4 shows the structure of a log entry 402 for recording admissibility determinations, in accordance with some embodiments.

The log entry 402 may be generated by processing logic as part of a structured admissibility record. In some embodiments, processing logic generates a structured admissibility record for each evaluated system-level output object. The log entry 402 may be stored, by processing logic, in an audit layer and may be used for replay, compliance review, debugging, incident investigation, liability analysis, regulatory reporting, future admissibility determinations, training and evaluation of autonomous agent systems, or enterprise oversight.

The log entry 402 may include a system-level output object identifier 404. The system-level output object identifier 404 uniquely identifies the system-level output object that was evaluated, enabling correlation between the log entry 402 and the corresponding system-level output object for traceability, replay, and audit purposes. In some embodiments, processing logic may generate and store a log entry 402 for each and every system-level output object that is generated, to maintain a complete history of the system's actions.

The log entry 402 may include one or more constraints evaluated 406 for a corresponding system-level output object, thereby maintaining a link between the system's response to an input and how an output was evaluated before it is allowed to pass or modified or blocked. The one or more constraints evaluated 406 may include violated constraint identifiers, satisfied constraint identifiers, or both, indicating which constraints from the constraint registry were evaluated against the system-level output object and whether each constraint was violated or satisfied.

The log entry 402 may include one or more evaluation results 408. The one or more evaluation results 408 may include the admissibility state determined for the system-level output object, which may include admissible, conditionally admissible, partially admissible, degraded-admissible, delayed, escalated, or inadmissible. The one or more evaluation results 408 may include component-level admissibility states for individual components 324 of the execution plan 306, for individual agent outputs 304, or both. The one or more evaluation results 408 may also include authority basis, provenance basis, permitted components, blocked components, modified components, degradation applied, or reason code indicating the rationale for the admissibility determination.

The log entry 402 may include action performed 410. The action performed 410 may indicate the execution-control action taken by the execution control gate based on the admissibility determination. The action performed 410 may be an indication of the execution plan 306 and components thereof. The action performed 410 may include allowing the output, blocking the output, modifying or transforming the output, redacting part of the output, inserting a constraint-compliant alternative, delaying execution, requiring higher-level approval, escalating to another authority level, routing the output to an external validation system, executing admissible subcomponents while blocking inadmissible subcomponents, splitting the output into component-level admissibility paths, preventing externalization while preserving internal state, sandboxing the output, rate-limiting execution, requiring user confirmation, requiring human-in-the-loop review, marking the output for audit or review, or converting the output into a degraded admissible form.

The log entry 402 may include time data 412. The time data 412 may include a timestamp indicating when the admissibility evaluation was performed and when the execution-control action was taken. The time data 412 supports temporal analysis, sequencing, and correlation of admissibility determinations over time.

The log entry 402 may include other data 414. The other data 414 may include escalation route, dependency graph, re-evaluation condition, or any other data useful for replay, compliance review, debugging, incident investigation, or future admissibility evaluation. The dependency graph may indicate dependency relationships among output components that were evaluated. The re-evaluation condition may specify conditions under which the admissibility determination should be re-evaluated.

The log entry 402 may include entry hash 416. The entry hash 416 may comprise a cryptographic hash of the log entry 402, enabling tamper detection and integrity verification. Processing logic may generate the entry hash 416 by applying a cryptographic hash function to the contents of the log entry 402.

The log entry 402 may be incorporated, in some embodiments, into a Merkle tree 418. The Merkle tree 418 is a cryptographic data structure that organizes log entries in a tree format, where each leaf node contains a data hash (such as the entry hash 416) and each parent node contains the hash of its child nodes, culminating in a single root hash (a Merkle root). The Merkle tree 418 enables efficient and secure verification of the integrity of log entries by allowing proofs of inclusion or consistency without requiring access to the entire dataset. Processing logic may order log entry hashes chronologically, generate a Merkle tree data structure over the hashes to obtain a Merkle root, and store the Merkle root and the ordered hashes in a data storage.

The log entry 402 may include or be associated with a cryptographic signature 420. The cryptographic signature 420 may be generated by signing the Merkle root with a cryptographic key. In some embodiments, processing logic signs the Merkle root with a first cryptographic key (such as a private key) and stores the Merkle root, the ordered hashes, and a corresponding second cryptographic key (such as a public key) to a data storage, which may comprise a distributed ledger. The cryptographic signature 420 enables authenticity verification and non-repudiation, proving who created or approved the log entries. This supports immutable storage of admissibility determinations, enhances traceability, detectability of tampering, and compliance with regulatory or audit requirements. Other data structures and cryptographic algorithms may be used to store and authenticate each log entry 402, without departing from the scope of the present disclosure.

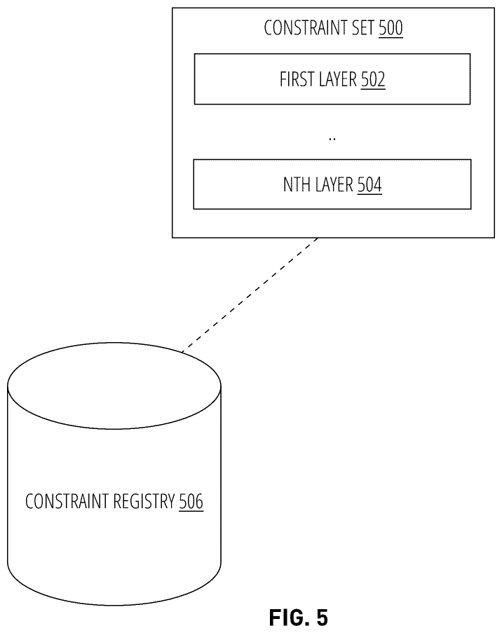

FIG. 5 shows a constraint set 500 and a constraint registry 506 for storing and organizing constraints in a hierarchical structure, in accordance with some embodiments.

The constraint set 500 represents the set of constraints that may be applicable to admissibility evaluation of a system-level output object. The constraint set 500 may include authority constraints, domain constraints, interaction constraints, temporal constraints, system-state constraints, stateful-sequence constraints, risk constraints, regulatory constraints, safety constraints, organizational constraints, human-approval constraints, cross-system governance constraints, or other constraints. The constraint set 500 may be organized as a hierarchical structure comprising a plurality of layers, where constraints in higher layers take precedence over constraints in lower layers during admissibility evaluation.

The constraint set 500 may include a first layer 502, which represents the highest-precedence layer in the hierarchical structure. The first layer 502 may include non-optimizable constraints, safety constraints, regulatory constraints, and authority constraints. Non-optimizable constraints may include constraints that are not modifiable, overridable, optimized, learned away, subordinated, or adapted by the autonomous agent ensemble. Safety constraints may define safety thresholds, fail-safe policies, and harm-prevention rules. Regulatory constraints may define legal restrictions, compliance requirements, jurisdiction-specific rules, and external governance requirements. Authority constraints may define authority limits, permission boundaries, and scope-of-action restrictions. Constraints in the first layer 502 may be enforced authoritatively, deterministically, or fail-closed, and may override constraints in all lower layers.

The constraint set 500 may include one or more intermediate layers between the first layer 502 and an nth layer 504. In some embodiments, intermediate layers may include organizational constraints, domain constraints, system-state constraints, and cross-system governance constraints. Organizational constraints may define organization-specific policies, approval requirements, and internal governance rules. Domain constraints may define domain boundaries, domain-specific rules, and permitted areas of operation. System-state constraints may define system-state conditions, interaction boundaries, and trust-domain boundaries. Cross-system governance constraints may define rules governing interactions among multiple systems, external validation requirements, and inter-system coordination policies.

The constraint set 500 may include an nth layer 504, which represents the lowest-precedence layer in the hierarchical structure. The nth layer 504 may include task-level constraints, role-level constraints, agent-level constraints, workflow constraints, agent preferences, and user convenience preferences. Task-level constraints may define constraints specific to a particular task or operation. Role-level constraints may define constraints associated with the role of the agent or actor performing the action. Agent-level constraints may define constraints specific to a particular agent or class of agents. Workflow constraints may define procedural requirements and step-specific rules. Constraints in the nth layer 504 may be overridden by constraints in higher layers when conflicts arise.

In some embodiments, the first layer 502 may include non-optimizable constraints and the nth layer 504 may include agent preferences, internal agent evaluations, or user convenience preferences. In such embodiments, the non-optimizable constraints in the first layer 502 may override the agent preferences, internal agent evaluations, or user convenience preferences in the nth layer 504, such that the non-optimizable constraints are enforced regardless of agent-generated confidence signals, internal agreement, reward scores, self-evaluation, critic-agent approval, or consensus among agents.

In some embodiments, the first layer 502 may include regulatory constraints and safety constraints, and a subsequent layer may include local task constraints and workflow constraints. In such embodiments, the regulatory constraints and safety constraints in the first layer 502 may override the local task constraints and workflow constraints in the subsequent layer, such that regulatory requirements, safety thresholds, and legal restrictions take precedence over task-specific rules and procedural requirements.

The constraint registry 506 stores the constraint set 500 and associated metadata. The constraint registry 506 may store machine-readable constraints, constraint precedence rules, constraint inheritance relationships, role definitions, authority levels, permissions, risk thresholds, escalation rules, temporal constraints, approval requirements, external validation requirements, and execution target rules. The constraint registry 506 may be local, distributed, hierarchical, cryptographically verifiable, administratively configured, dynamically updated, or synchronized with external policy, identity, compliance, legal, regulatory, or authorization systems.

In an embodiment, the hierarchical structure of the constraint set 500 may be implemented as a tree data structure with parent-child relationships, a hash-linked list, a policy graph, or other data structure that preserves layer ordering and precedence relationships. During admissibility evaluation, processing logic may traverse the hierarchical structure from the first layer 502 toward the nth layer 504, evaluating constraints in order of precedence. In an embodiment, when constraints conflict, processing logic may resolve the conflict by applying the constraint from the higher-precedence layer, or by applying constraint conflict resolution mechanisms such as predefined priority ordering, regulatory supremacy rules, safety precedence rules, or fail-closed blocking.

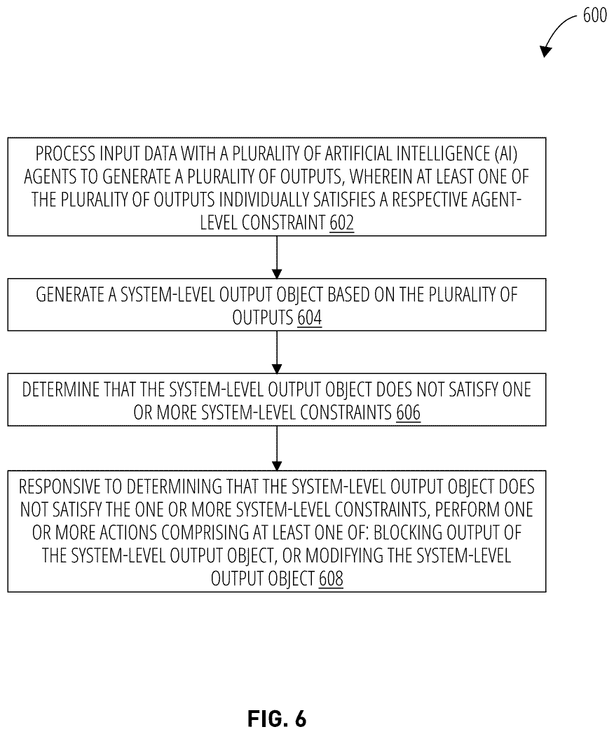

FIG. 6 illustrates an example method 600 for system-level output admissibility control, in accordance with some embodiments. Although the example method 600 depicts a particular sequence of operations, the sequence may be altered without departing from the scope of the present disclosure. Method 600 may be performed by processing logic which may be integral to one or more processing devices. Processing logic may comprise hardware (e.g., circuitry, dedicated logic, programmable logic, a processor, a processing device, a central processing unit (CPU), a system-on-chip (SoC), etc.), software (e.g., instructions stored in memory executed by a processing device), firmware (e.g., microcode), or a combination thereof. Method 600 may correspond to operations described in other sections and in any of the other figures.

At block 602, processing logic may process input data with a plurality of artificial intelligence (AI) agents to generate a plurality of outputs, wherein at least one of the plurality of outputs individually satisfies a respective agent-level constraint. Each AI agent may operate under its own agent-level constraints, which may define the permissible actions, domain boundaries, and output characteristics for that individual agent. An output that satisfies an agent-level constraint may still be subject to further evaluation at the system level.

At block 604, processing logic may generate a system-level output object based on the plurality of outputs. The system-level output object may represent a sum, concatenation, combination, synthesis, or subset of the individual agent outputs. Processing logic may preserve provenance metadata, tag contributing agents, identify intended external effects, and preserve execution dependencies when generating the system-level output object.

At block 606, processing logic may determine that the system-level output object does not satisfy one or more system-level constraints. The one or more system-level constraints may include authority constraints, domain constraints, interaction constraints, temporal constraints, system-state constraints, stateful-sequence constraints, risk constraints, regulatory constraints, safety constraints, or organizational constraints. In some embodiments, at least one of the plurality of outputs individually satisfies a respective agent-level constraint. In some embodiments, at least two of the plurality of outputs individually satisfy respective agent-level constraints. In some embodiments, each of the plurality of outputs individually satisfies a respective agent-level constraint. Processing logic may determine that the system-level output object is inadmissible even when each contributing agent output individually satisfies its respective agent-level constraint, such that individually permissible contributions become impermissible when combined, sequenced, or externalized together.

At block 608, responsive to determining that the system-level output object does not satisfy the one or more system-level constraints, processing logic may perform one or more actions comprising at least one of: blocking output of the system-level output object, or modifying the system-level output object. Processing logic may also delay execution, require higher-level approval, escalate to another authority level, route the output to an external validation system, sandbox the output, or convert the output into a degraded admissible form. Processing logic may apply these actions at an externalization boundary before permitting a proposed external effect of the system-level output object.

In an embodiment, the determining at block 606 is based on evaluating the system-level output object in view of one or more prior system-level output objects. Processing logic may compare the proposed system-level output object against previously permitted, blocked, or evaluated outputs to identify inadmissible sequences, patterns, or cumulative effects.

In an embodiment, the evaluating comprises detecting a constraint violation based on a sequence, repetition, or aggregation of the system-level output object and the one or more prior system-level output objects, or based on a corresponding disposition of the one or more prior system-level output objects. Processing logic may determine that an output that is individually admissible becomes inadmissible when considered in sequence with prior outputs. In some embodiments, the evaluating comprises detecting a constraint violation based on an admissibility disposition of one or more prior system-level output objects, wherein the admissibility disposition comprises one or more of: permitted, blocked, modified, degraded, escalated, delayed, sandboxed, or inadmissible. Processing logic may maintain or access an admissibility state history comprising admissibility dispositions of prior system-level output objects, and may evaluate a current system-level output object based on the admissibility dispositions of multiple prior system-level output objects to determine whether the current output creates an inadmissible transition, exceeds cumulative thresholds, repeats a previously rejected action, bypasses an approval sequence, or produces an unauthorized aggregate effect.

In an embodiment, the system-level output object comprises metadata associating each of the plurality of outputs with a corresponding one of the plurality of AI agents. The determining that the system-level output object does not satisfy the one or more system-level constraints may comprise determining, based on the metadata, that an action represented by the system-level output object exceeds an authority scope of one or more of the plurality of AI agents. For example, an action may require outputs from agents operating under particular authority scopes, and the system-level output object may be inadmissible if the contributing agents lack sufficient authority scope for the proposed action. In another example, an action may require approval outputs from multiple designated agents, and the system-level output object may be inadmissible if an approval output is missing or was provided by a non-designated agent.

In an embodiment, processing logic may generate and store a log entry comprising: an identifier of the system-level output object, an indication of the one or more system-level constraints evaluated, an indication of whether the one or more system-level constraints were satisfied, and an indication of the one or more actions performed. The log entry may support traceability, compliance review, debugging, incident investigation, or regulatory reporting.

In an embodiment, the determining that the system-level output object does not satisfy the one or more system-level constraints comprises determining that one or more components of the system-level output object do not satisfy the one or more system-level constraints. The performing the one or more actions may comprise modifying the one or more components that do not satisfy the one or more system-level constraints while permitting output of remaining components. This enables component-level admissibility evaluation and partial execution of admissible subcomponents.

In an embodiment, the one or more system-level constraints are dependent on a time associated with processing the input data, such that the system-level output object satisfies the one or more system-level constraints at a first time and does not satisfy the one or more system-level constraints at a second time. Processing logic may evaluate admissibility dynamically at or near the time of execution or externalization based on changes in authority scope, domain constraints, system state, environmental context, risk thresholds, or regulatory requirements.

In an embodiment, the one or more system-level constraints are retrieved from a constraint registry that is external to and not modifiable by the plurality of AI agents. The constraint registry may be maintained by an administrative authority, compliance system, or governance layer that operates independently of the agent ensemble, such that the constraints are not subject to optimization, modification, override, or subordination by any of the plurality of AI agents. The constraint registry may include non-optimizable constraints that are enforced regardless of agent-generated confidence signals, internal agreement, reward scores, self-evaluation, critic-agent approval, or consensus among agents.

In an embodiment, responsive to determining that the system-level output object does not satisfy the one or more system-level constraints, processing logic escalates the system-level output object to require human approval before execution or externalization. Processing logic may route the system-level output object to a human reviewer, supervisor, or approval authority, and may block execution or externalization until human approval is received. Human approval may be required when the system-level output object exceeds a risk threshold, violates a regulatory constraint, requires authorization beyond the authority scope of the plurality of AI agents, or when the admissibility determination cannot be resolved automatically.

In an embodiment, responsive to determining that the system-level output object does not satisfy the one or more system-level constraints, processing logic converts the system-level output object into a degraded admissible form. The degraded admissible form may comprise a reduced, constrained, redacted, rate-limited, sandboxed, reversible, or lower-authority version of the system-level output object. Processing logic may permit execution or externalization of the degraded admissible form while blocking execution of the originally proposed system-level output object. This enables soft enforcement in which an output that is not fully admissible as proposed may still be executed in a modified form that satisfies applicable constraints.

In an embodiment, the one or more system-level constraints comprise a plurality of constraints organized in a hierarchical structure, wherein one or more higher-level constraints take precedence over one or more lower-level constraints. The one or more higher-level constraints may comprise regulatory constraints, safety constraints, or authority constraints. The one or more lower-level constraints may comprise local task constraints, workflow constraints, or agent-generated constraints. When constraints conflict, processing logic may resolve the conflict by applying the constraint from the higher-precedence level, such that regulatory, safety, and authority constraints override local task, workflow, and agent-generated constraints.

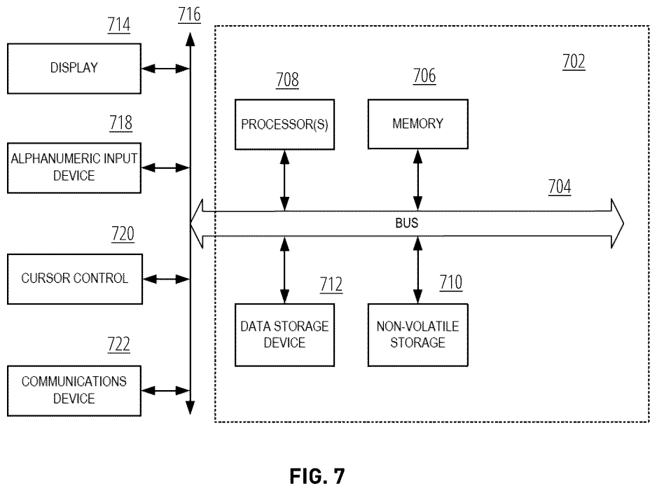

FIG. 7 is one embodiment of a computer system that may be used to support the systems and operations described, in accordance with an embodiment. For example, FIG. 7 may show a computer system and/or processing logic as described in other sections.

The computer system 702 illustrated in FIG. 7 includes a bus or other internal communication means 704 for communicating information, and one or more processors 708 coupled to the bus 704 for processing information. The system further comprises a random access memory (RAM) or other volatile storage device 706 (referred to as memory), coupled to bus 704 for storing information and instructions to be executed by processor 708. Main memory 706 also may be used for storing temporary variables or other intermediate information during execution of instructions by processor 708. The system also comprises a read only memory (ROM), non-volatile storage, and/or static storage device 710 coupled to bus 704 for storing static information and instructions for processor 708, and a data storage device 712 such as a magnetic disk or optical disk and its corresponding disk drive. Data storage device 712 is coupled to bus 704 for storing information and instructions.

The system may further be coupled to a display device 714, such as a light emitting diode (LED) display or a liquid crystal display (LCD) coupled to bus 704 through bus 716 for displaying information to a computer user. An alphanumeric input device 718, including alphanumeric and other keys, may also be coupled to bus 704 through bus 716 for communicating information and command selections to processor 708. An additional user input device is cursor control device 720, such as a touchpad, mouse, a trackball, stylus, or cursor direction keys coupled to bus 704 through bus 716 for communicating direction information and command selections to processor 708, and for controlling cursor movement on display device 714.

Another device, which may optionally be coupled to computer system 702, is a communication device 722 for accessing other nodes of a distributed system via a network. The communication device 722 may include any of a number of commercially available networking peripheral devices such as those used for coupling to an Ethernet, token ring, Internet, or wide area network. The communication device 722 may further be a null-modem connection, or any other mechanism that provides connectivity between the computer system 702 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 706, mass storage device 712, or other storage medium locally or remotely accessible to processor 708.

It will be apparent to those of ordinary skill in the art that the system, method, and process described herein can be implemented as software stored in main memory 706 or read only memory and executed by processor 708. This control logic or software may also be resident on an article of manufacture comprising a computer readable medium having computer readable program code embodied therein and being readable by the mass storage device 712 and for causing the processor 708 to operate in accordance with the methods and teachings herein.

The embodiments discussed herein may also be embodied in a handheld or portable device containing a subset of the computer hardware components described above. For example, the handheld device may be configured to contain only the bus 704, the processor 708, and memory 706 and/or 712. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 708, a data storage device 712, a bus 704, and memory 706, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, performed by a computer system, comprising:
processing input data with a plurality of artificial intelligence (AI) agents to generate a plurality of outputs, wherein at least one of the plurality of outputs individually satisfies a respective agent-level constraint;
generating a system-level output object based on the plurality of outputs;
determining that the system-level output object does not satisfy one or more system-level constraints; and
responsive to determining that the system-level output object does not satisfy the one or more system-level constraints, performing one or more actions comprising at least one of:
blocking output of the system-level output object, or modifying the system-level output object.

2. The method of claim 1, wherein the determining is based on evaluating the system-level output object in view of one or more prior system-level output objects.

3. The method of claim 2, wherein the evaluating comprises detecting a constraint violation based on a sequence, repetition, or aggregation of the system-level output object and the one or more prior system-level output objects or based on a corresponding disposition of the one or more prior system-level output objects.

4. The method of claim 1, wherein the system-level output object comprises metadata associating each of the plurality of outputs with a corresponding one of the plurality of AI agents, and wherein determining that the system-level output object does not satisfy the one or more system-level constraints comprises determining, based on the metadata, that an action represented by the system-level output object exceeds an authority scope of one or more of the plurality of AI agents.

5. The method of claim 1, further comprising: generating and storing a log entry comprising: an identifier of the system-level output object, an indication of the one or more system-level constraints evaluated, an indication of whether the one or more system-level constraints were satisfied, and an indication of the one or more actions performed.

6. The method of claim 1, wherein determining that the system-level output object does not satisfy the one or more system-level constraints comprises determining that one or more components of the system-level output object do not satisfy the one or more system-level constraints; and wherein performing the one or more actions comprises blocking or modifying the one or more components that do not satisfy the one or more system-level constraints while permitting output of remaining components.

7. The method of claim 1, wherein the one or more system-level constraints are dependent on a time associated with processing the input data, such that the system-level output object satisfies the one or more system-level constraints at a first time and does not satisfy the one or more system-level constraints at a second time.

8. The method of claim 1, wherein the one or more system-level constraints are retrieved from a constraint registry that is external to and not modifiable by the plurality of AI agents.

9. The method of claim 1, wherein at least two of the plurality of outputs individually satisfy respective agent-level constraints, and wherein the system-level output object is determined to not satisfy the one or more system-level constraints based on a combination, sequence, or aggregation of the at least two outputs.

10. A system comprising:
a memory; and
a processing device, operatively coupled to the memory, to:
process input data with a plurality of artificial intelligence (AI) agents to generate a plurality of outputs, wherein at least one of the plurality of outputs individually satisfies a respective agent-level constraint;
generate a system-level output object based on the plurality of outputs;
determine that the system-level output object does not satisfy one or more system-level constraints; and
responsive to determining that the system-level output object does not satisfy the one or more system-level constraints, perform one or more actions comprising at least one of:
blocking output of the system-level output object, or modifying the system-level output object.

11. The system of claim 10, wherein to determine that the system-level output object does not satisfy the one or more system-level constraints comprises to evaluate the system-level output object in view of one or more prior system-level output objects.

12. The system of claim 11, wherein to evaluate comprises to detect a constraint violation based on a sequence, repetition, or aggregation of the system-level output object and the one or more prior system-level output objects or based on a corresponding disposition of the one or more prior system-level output objects.

13. The system of claim 10, wherein the system-level output object comprises metadata associating each of the plurality of outputs with a corresponding one of the plurality of AI agents, and wherein to determine that the system-level output object does not satisfy the one or more system-level constraints comprises to determine, based on the metadata, that an action represented by the system-level output object exceeds an authority scope of one or more of the plurality of AI agents.

14. The system of claim 10, wherein the processing device is further to: generate and store a log entry comprising: an identifier of the system-level output object, an indication of the one or more system-level constraints evaluated, an indication of whether the one or more system-level constraints were satisfied, and an indication of the one or more actions performed.

15. The system of claim 10, wherein to determine that the system-level output object does not satisfy the one or more system-level constraints comprises to determine that one or more components of the system-level output object do not satisfy the one or more system-level constraints; and wherein to perform the one or more actions comprises to block or modify the one or more components that do not satisfy the one or more system-level constraints while permitting output of remaining components.

16. A non-transitory computer-readable storage medium comprising instructions that, when executed by a processing device, cause the processing device to:
process input data with a plurality of artificial intelligence (AI) agents to generate a plurality of outputs, wherein at least one of the plurality of outputs individually satisfies a respective agent-level constraint;
generate a system-level output object based on the plurality of outputs;
determine that the system-level output object does not satisfy one or more system-level constraints; and
responsive to determining that the system-level output object does not satisfy the one or more system-level constraints, perform one or more actions comprising at least one of:
blocking output of the system-level output object, or modifying the system-level output object.

17. The non-transitory computer-readable storage medium of claim 16, wherein to determine that the system-level output object does not satisfy the one or more system-level constraints comprises to evaluate the system-level output object in view of one or more prior system-level output objects.

18. The non-transitory computer-readable storage medium of claim 17, wherein to evaluate comprises to detect a constraint violation based on a sequence, repetition, or aggregation of the system-level output object and the one or more prior system-level output objects or based on a corresponding disposition of the one or more prior system-level output objects.

19. The non-transitory computer-readable storage medium of claim 16, wherein the system-level output object comprises metadata associating each of the plurality of outputs with a corresponding one of the plurality of AI agents, and wherein to determine that the system-level output object does not satisfy the one or more system-level constraints comprises to determine, based on the metadata, that an action represented by the system-level output object exceeds an authority scope of one or more of the plurality of AI agents.

20. The non-transitory computer-readable storage medium of claim 16, wherein the processing device is further to: generate and store a log entry comprising: an identifier of the system-level output object, an indication of the one or more system-level constraints evaluated, an indication of whether the one or more system-level constraints were satisfied, and an indication of the one or more actions performed.
